(19) United States
(12) Patent Application Publication
(10) Pub. No.: US 2002/0077853 A1
(43) Pub. Date: Jun. 20, 2002

(54) System for selecting clinical trials

(76) Inventors: Kevin Boru, San Francisco, CA (US); Trevor Fooks, San Francisco, CA (US)

Correspondence Address: Peter C. Knops, Lathrop & Gage LC, Suite 2800, 2345 Grand Boulevard, Kansas City, MO, 64108, US

(21) Appl. No.: 09/952,797

(22) Filed: Sep. 14, 2001

Related U.S. Application Data
(60) Provisional application No. 60/233,301, filed on Sep. 15, 2000.

(51) Int. Cl. G06F 17/60

(52) U.S. Cl. 705/2

(57) ABSTRACT

A system for identifying and selecting a clinical trial, suitable for a specific patient, from a database. Initially, a database of clinical studies, such as the clinicaltrials.gov database, is searched to find the trials specific to a particular disease. All of the clinical trials in the disease-specific area are then extracted from the database. Next, all of the ‘exclusionary criteria’ listed in each trial are then identified and extracted. After identifying all of the criteria cumulatively across all of the clinical trials, a list is made of the criteria having the most redundancy, i.e., the criteria that are common to a predetermined number of the trials. The criteria is then ‘normalized’, or standardized, by assigning a single, consistent category for generating questions that can be answered by either “yes/no”, or selecting one of a small number of predetermined ranges. Finally, the number of criteria is reduced by eliminating the least exclusionary criteria. This reduction of redundant criteria allows the present system to thereafter generate a minimal list of questions that exclude the greatest number of trials for which a patient's medical condition does not qualify him or her. In operation, the patient or the patient's physician answers a set of questions using the information from the patient's medical record. In most cases, the present search engine generates the desired results of approximately 5 to 10 applicable clinical trials.

### BACKGROUND OF THE INVENTION

1. Technical Field

The present invention relates generally to clinical trials and more particularly, to a method for identifying and selecting a clinical trial, suitable for a specific patient, from a database.

2. Statement of the problem

A significant problem presently exists in facilitating the selection of an appropriate clinical trial by a patient with a refractory or untreatable disease, i.e., diseases likely to result in death or a significant reduction in quality of life, such as certain types of cancer, debilitating rheumatoid arthritis, multiple sclerosis and the like. If one wants to take advantage of one or more existing databases containing voluminous data on clinical trials presently in progress, reliance on previously existing methods for clinical trial selection have proven to be fraught with problems, as detailed below.

It has been known for some time that there exists a problem with the adult clinical trial system in the United States, in which, even with respect to such diseases as cancer, participation by potentially qualified candidates is as low as 3 to 4 percent. The National Cancer Institute and other reputable organizations have made estimates that as many as 33 percent of cancer patients would likely be better served by clinical trials than the best standard (non-trial) treatment, and as a result a considerable amount of money has been spent on research into reasons for this significant discrepancy.

It has only been recently that an article was published concerning the reasons for physicians themselves not making more referrals of patients. See, “Surveys identify Barriers to Participation in Clinical Trials”, by Robert Finn, Journal of the National Cancer Institute, Oct. 2000. It is important to realize that prior to this article, most of the earlier studies focused not on the MD, but on the interested patient's (1) need for access to the information on trials and (2) need for insurance company payment of the patient's costs to participate which were not already paid by pharmaceutical companies.

One answer to the first issue—the need for better access to information—was the 1997 FDA Modernization Act, which provides for the creation of the National Library of Medicine's “www.clinicaltrials.gov” site. Prior to the creation of this site, there was no mandated single repository for such information, although various sites attempted to provide clinical trial information on a piecemeal basis. Given the existence of a central repository, there is now a need to be able to effectively and efficiently access this database.

An answer to the second issue—the need for insurance coverage to include participation in clinical trials—is being provided by federal and individual state “Patients Bill of Rights” legislation. Many states now require health insurance to cover at least some of the cost of clinical trials, and there is a national bill which has been proposed to require this extension of coverage, as well.

Accordingly, there is a need for a technical innovation to make the www.clinicaltrials.gov site efficiently useful. If one were to search this central site for the topic of “breast cancer”, one would be able to narrow down the very large number of available clinical trials only on the basis of the rather simplistic criteria of (1) location, (2) the phase of the trial, and (3) generalized keywords such as ‘metastatic’, ‘refractory’, ‘advanced’, etc. Use of this inefficient search engine has the consequences requiring a huge amount of reading and sorting through the large number of resultant trials which may or may not fit a particular patient's real case. This situation is quite impractical for the patient, as physicians are not reimbursed (by managed care groups) for performing clinical trial referrals, and physicians typically have little time for such activity, especially on a charitable basis.

Although physicians have some incentive to sidestep the potential liability of not informing patients of the existence of appropriate available clinical trials, it is perhaps not sufficient simply to threaten physicians with potential lawsuits in order to have them make clinical trial referrals on a regular basis. The additional incentive that makes it practical for physicians to routinely provide referrals is to get pharmaceutical companies to provide an affiliated physician with ‘fair compensation’ for performing the work required to enter patients into clinical trials. Presently, the average nonaffiliated physician gets about $75 per referral, while the average clinical trial affiliated physician gets about $3000.

Two approaches presently exist, neither of which is relatively efficient. One approach targets the patient and assists the patient in obtaining the clinical trial information for him or herself. The underlying philosophy is that there is no need to reduce the typically large number of search results, since the very ill (or their families) have the time and interest to pore over a vast number of trials. The second approach is employed by an organization that requires the patient to utilize doctors employed by the organization, rather than allowing patients to work with their own doctor. The problem with both of these approaches is that studies have shown that neither one of them works very well.

On the one hand, patients do not have the knowledge or confidence in the vast majority of cases to read studies and make life and death decisions, while on the other hand physicians are decidedly uninterested in reading hundreds of clinical trials that a patient may find, for example, on the Internet. Patients also tend to strongly not trust physicians whom they know to be affiliated with clinical trials, for the simple reason that they often believe that these physicians are more concerned with the clinical study than with the patient's health. The Journal of the National Cancer Institute study cited above shows that patients tend to trust physicians affiliated with clinical trials only 31 percent of the time, while another study (not cited herein) shows that patients tend to trust their own physicians more than 95 percent of the time. Yet another study indicates that patients who have entered clinical trials are 13 times more likely to have entered them on the advice of their own doctor than as a result of information supplied by any other source.

Presently, it is basically physicians with a vested interest in the trials who are recruiting the patients for the trials, rather than the patients' own physicians, whose primary interest is their patients' health. Therefore, in order to get more patients into clinical trials, there must be a mechanism for creating a manageable and adequately remunerated set of tasks for the MD to perform to make the referral.

Solution to the Problem

The present system provides a solution to the above problem by addressing at least two different aspects of the problem. First of all, the present system identifies that it is the patient's attending physician, rather than a physician affiliated with a clinical trial and thus having a possible conflict of interests, who is best positioned to suggest to a patient one or more clinical trials most appropriate for the particular patient's medical needs. Secondly, the present system provides a mechanism for effectively facilitating the selection of the most appropriate clinical trials by the physician.

The first of the issues set forth above in the ‘Problem’ section, ‘the need for information’ is directly addressed by the present search engine. The second issue, ‘the need for insurance coverage to include participation in clinical trials,’ is essentially moot because patients' ability to pay for their clinical trial participation is no longer a problem.

The present system facilitates identification of the most appropriate clinical trials by employing the “Exclusionary Criteria” already listed in the public clinicaltrials.gov site. This Exclusionary Criteria, for example, may include stipulations that a patient cannot enter a certain trial because he has unhealthy creatinine levels, or bilirubin levels, or his cancer is metastatic to the brain, etc.

The Patients Bill of Rights legislation effectively suggests that clinical trials must be thought of as a viable medical option, and as such, a doctor has a duty to inform patients about them. One significant benefit of the present system is that it enables physicians to be preemptive and take action against the liabilities they could incur if they do not inform potential terminal patients about clinical trials for which they might be qualified. This is quite simply accomplished by the simple steps of performing a search using the preset search engine, and inserting just a few resulting sheets of paper into the patient's file, after providing the patient with a brief explanation of the nature of clinical trials in general.

Initially, the present system searches a database of clinical studies, such as the clinicaltrials.gov database, to find the trials specific to a particular disease. All of the clinical trials in the disease-specific area are then extracted from the database. Next, all of the ‘exclusionary criteria’ listed in each trial are then identified and extracted. After identifying all of the criteria cumulatively across all of the clinical trials, a list is made of the criteria having the most redundancy, i.e., the criteria that are common to a predetermined number of the trials. The criteria is then ‘ormalized’ or standardized by assigning a single, consistent category for generating questions that can be answered by either “yes/no”, or selecting one of a small number of predetermined ranges. Finally, the number of criteria is reduced by eliminating the least exclusionary criteria.

This reduction of redundant criteria allows the present system to thereafter generate a minimal list of questions that exclude the greatest number of trials for which a patient's medical condition does not qualify him or her. In operation, the patient or the patient's physician answers a set of questions using the information from the patient's medical record. In most cases, the present search engine generates the desired results of approximately 5 to 10 applicable clinical trials. This is a vastly reduced number in comparison to the number of results provided by existing methods (which typically return a large number of search results, frequently in excess of one hundred), and is manageable by the attending physician, even under very time-constrained working conditions.

### BRIEF DESCRIPTION OF THE DRAWINGS

FIG. 1 is a diagram illustrating data flow paths in the present system;

FIG. 2 is a flowchart illustrating, at a high level, steps which may be performed in practicing one embodiment of the method of the present system;

FIG. 3 is a flowchart illustrating exemplary steps which are be performed by the search engine of the present system to process a user query;

FIG. 4 is a flowchart illustrating an exemplary method for optimizing the exclusionary criteria used by the search engine; and

FIG. 5 is a diagram showing the forms in which data is stored to facilitate processing by the present system.

### DETAILED DESCRIPTION

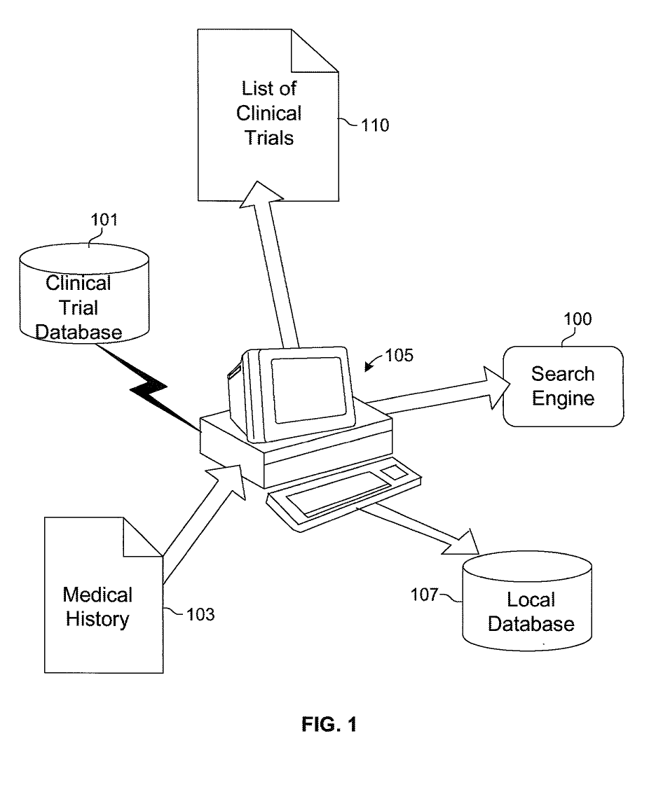

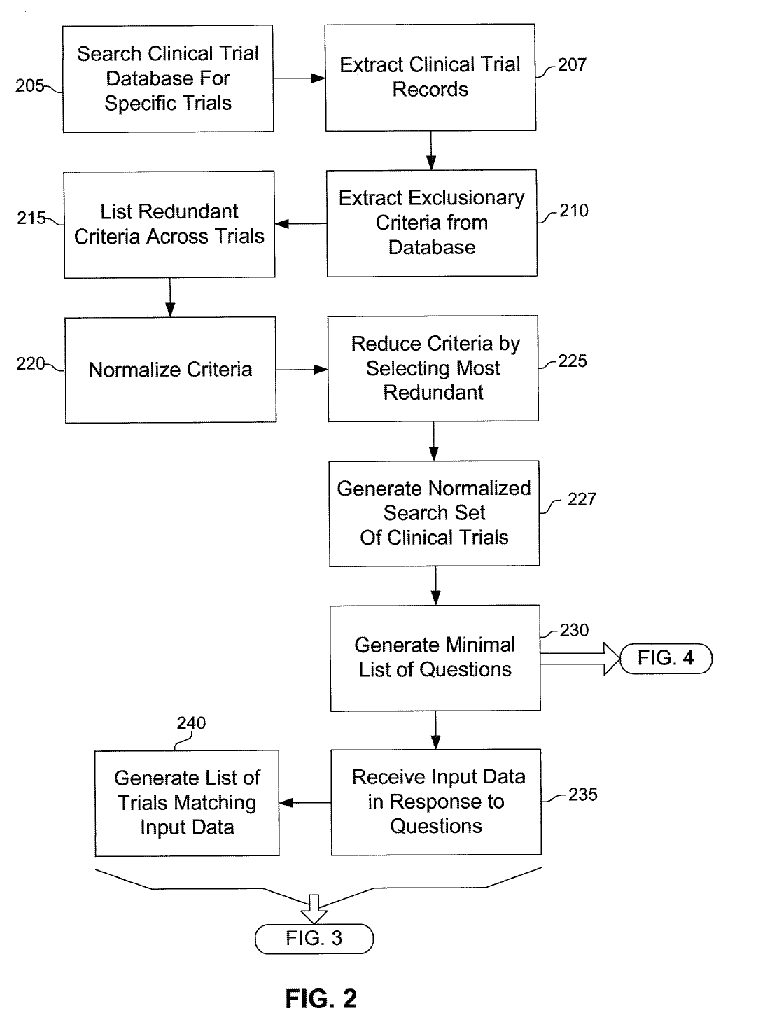

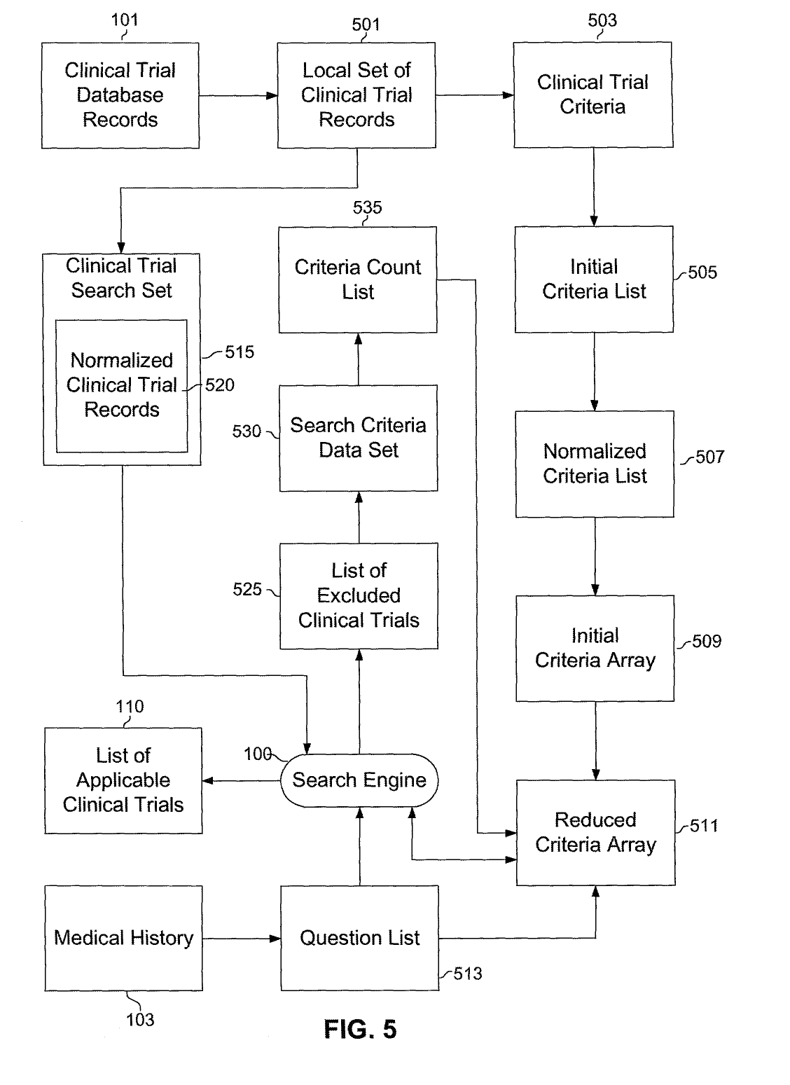

FIG. 1 is a diagram illustrating data flow paths between certain components in the present system. FIG. 2 is a flowchart illustrating, at a high level, steps which may be performed in practicing one embodiment of the method of the present system. FIG. 5 is a diagram showing data flow during processing by the present system. Operation of the system is best understood by viewing FIGS. 1 and 5 in conjunction with FIG. 2 and each figure subsequently described below.

As shown in FIGS. 1 and 2, initially, at step 205, a database 101 of clinical studies, such as the clinicaltrials.gov database, is searched to find the trials specific to an area of interest, for example, a particular disease. This search is performed by search engine 100 running on a computer 105 that accesses database 101 via the Internet, for example. At step 207, all of the clinical trial exclusionary criteria related to a specific disease (breast cancer, in the present example) are extracted from the database (or databases) of interest 101 and stored as a ‘search set’ 501 of clinical trial records in a local database 107 coupled to, or otherwise accessible by, computer 105. Examples of exclusionary criteria (typically referred to as “eligibility” criteria) for three clinical trials appear in Tables CT1, CT2, and CT3, below.

At step 210, all of, or some significant number of, the ‘exclusionary criteria’ listed in each trial are then identified and extracted from the database(s) and stored as a data set 503 of ‘clinical trial criteria’ in local database 107. For example, if abnormal liver function as indicated by bilirubin count, or abnormal kidney function as indicated by creatinine count, results in a patient being excluded from a clinical trial, these blood chemistry indicators are considered to be exclusionary criteria. See, for example, Table CT3 (below), where the hematopoietic exclusionary criteria in this particular clinical trial are given as:

20. Hepatic: Bilirubin no greater than 1.5 mg/dL

21. Renal: Creatinine no greater than 1.5 mg/dL

A different clinical trial (see Table CT1, below) lists the following hematopoietic (blood chemistry) exclusionary criteria:

18. Hepatic: Bilirubin less than 1.5 times upper limit of normal (ULN)

19. Renal: Creatinine less than 1.5 times ULN

Accordingly, the above exclusionary criteria may be stored in the clinical trial criteria data set 503 respectively as the following records (or entries):

“bilirubin <1.5 mg/dL”

“creatinine <1.5 mg/dL”“bilirubin <1.5 ULN”“creatinine <1.5 ULN”

At step 215, an initial criteria list 505 is made of the exclusionary criteria that are the most redundant across the clinical trials, i.e., the clinical trial criteria that appear most frequently throughout the search set 501 of clinical trial records.

At the beginning of this step, the clinical trial criteria are not standardized into a common format, and therefore, creation of the initial criteria list 505 involves choosing ‘common categories’ into which similar criteria, although having different English language descriptions, may be sorted. This sorting process entails resolving ambiguities between various non-standardized clinical trial criteria. For example, the value “1.5 ULN” (1.5 times the ‘upper limit of normal’) for bilirubin, alone entails some ambiguity. There is no universally accepted value for bilirubin ULN, therefore an estimated value, in the present case, 1.0 mg/dL is used. Perhaps 85 percent of the medical community agrees with this value, but it is, nevertheless, not a universally accepted value. An estimate must thus be made if this particular criterion is to be used in the search process.

The initial criteria list 505 may be generated by selecting the clinical trial criteria that are common to at least a minimum predetermined number of the trials. This initial list 505 of clinical trial criteria may consist of, for example, between 75 and 100 of the most commonly occurring criteria found in the clinical trial criteria data set 503. Other values may be chosen for number of criteria in the initial criteria list 505, keeping in mind that the initial elimination of too many criteria may adversely affect the ultimate outcome of the search process. As explained below, this identification of redundant exclusionary criteria allows the creation of a list of questions that exclude the greatest number of trials for which a patient's medical condition does not allow the patient to qualify.

At step 220, the clinical trial criteria in the initial criteria list 505 are ‘normalized’ (standardized) by assigning, to each of the criteria in the initial criteria list, a single, consistent search criterion name, or ‘tag’ for identifying each of the criteria and generating (phrasing) corresponding questions that can be answered by one of three types of response:

(a) entering “yes” or “no”; or

(b) selecting a scalar position within a predetermined range; or

(c) selecting one of a small number of predetermined ranges.

Two examples of clinical trial criteria, as they might appear in the initial criteria list 505 before being ‘normalized’ are as follows:

Bilirubin no greater than 1.5 mg/dL [see Table CT3]

Bilirubin less than 1.5 times upper limit of normal (ULN) [see Table CT1]

In practice, other clinical trials, in fact, employ other exclusionary criteria relating to bilirubin, with exclusionary values ranging from approximately 1.2 mg/dL to well over 2 mg/dL. As indicated above, since there is no universally accepted value for bilirubin ULN, an estimated value, in the present case, 1.0 mg/dL is used. After being normalized in accordance with the present system, the above criteria might be represented by, for example, four normalized sub-categories as follows (see Table 1):

(1) Bilirubin <1.30 mg/dL

(2) Bilirubin 1.30-1.49 mg/dL

(3) Bilirubin 1.50-1.99 mg/dL

(4) Bilirubin >2.00 mg/dL

Note that the clinical trial shown in Table CT1 and the clinical trial shown in Table CT2 are quite different in terms of the target patient lab values. In the first trial, a very low neutrophil count (“ANC”) of at least 1,500/ mm3 is used (criteria number 16). In contrast, in the second trial, the neutrophil count (criteria number 22) is substantially higher, at 2,000/ mm3. Note that the neutrophil count is called “ANC” in the first trial, and “granulocyte count” in the second trial, thus presenting an example of why normalization of nomenclature is required.

In addition, the criteria numbered 21 in the second study, “White Blood Cell” count, or WBC, is another example of where the normalization of terminology is required. White Blood Cells include the neutrophil count, but not vice versa. Many trials used one term or the other, thus the normalized subcategories “neutrophil <1,500/ mm3” and “neutrophil >1,500/ mm3” both use a “neutrophil” value as criteria in the exemplary question list 513 shown in Table 1.

Having been normalized, each of the above sub-categories is now considered to be a search criterion. Related criteria, such as the bilirubin and neutrophil counts shown above, could be processed as sub-elements of a common array member. However, in the present exemplary embodiment, the search criteria are processed by search engine 100 as separate entities in order to simplify the clinical trial search process. The normalized search criteria are stored in a normalized criteria list 507.

At step 225, the normalized search criteria in the normalized criteria list are further reduced in number and stored in local database 107 as an array 509 (termed the ‘initial criteria array’). This reduction is accomplished by selecting, from the initial criteria list generated in step 215, a predetermined maximum number of the normalized search criteria having the most redundancy across the set of trials. As indicated above, the number of search criteria in the initial criteria list may include between approximately 75 and 100 search criteria. Approximately 50 to 75 of the most redundant of these search criteria are selected from the normalized criteria list and used to generate the initial criteria array 509.

Initial criteria array 509 (as well as reduced criteria array 511, described below) is a one-dimensional array comprising a list of search criteria, each of which contain an entry that represents the answer (or lack thereof) to each of the questions (criteria) in the question list 513. Criteria array 509/511 has the following exemplary format:

criterion (1), criterion (2), . . . criterion (n)

An example of a segment of an exemplary criteria array 509/511 is represented by following:

Array Element No. C(9) C(10) C(11l) C(12) C(13)

Array Element . . . 1 0 0 1 0.

where each C(n) designates the search criteria number, wherein n designates the nth element (entry) in the criteria array, and the number below the criteria number represents the value of the corresponding criteria, which is determined by the data imported from question list 513. The above criteria array entries might correspond, for example, to entries in the “Hormonal/Endocrine Therapy” section of the question list shown in Table 1 (“Patient Question List”) as follows:

C(9)=Current Chemotherapy (x)

C(10)=Concurrent HRT (Hormone Replacement Therapy) ( )

C(11)=Concurrent use of Tamoxifen/Raloxifene ( )

C(12)=Prior hormonal Rx for breast cancer (x)

C(13)=Less than 4 weeks since hormonal Rx ( )

In one embodiment, an entry in the criteria 511 array contains one of three types of values, the first two of which are determined by the response (answers) to the questions in the question list 513 (described in step 230 below):

(1) a “1” if the criteria corresponds to a question that has been answered as being “applicable” in the question list;

(2) a scalar value other than 1 (such as age); or,

(3) a “0”.

Also, if a given question in the question list 513 has not been answered, the corresponding entry in the criteria array 511 is set to “0”. In either event, a “0” indicates that a particular search criterion can not be used to exclude a patient from a particular clinical trial.

Questions that do not have a “yes/no” format (i.e., where one of several answers is possible for a given question, as in the case of an answer that includes several ranges of values) are considered to consist of “sub-criteria”. Each of these sub-criteria is separately entered in both the criteria array 509/511. For example, in the “Status of Disease” section of the exemplary patient question list shown in Table 1, question number 4 relates to the specific stage of a patient's cancer:

Stage I ( ), IIa ( ), IIb ( ), IIIa ( ), IIIb ( ), IV ( )—choose the appropriate box

In this case, where there are several possible answers to a given question, each of the answers is treated as a sub-criterion. Accordingly, each of the stages in the above question is considered to be a distinct potential entry in both the criteria array 511 and the question list 513. For example, “stage I” might be represented by array element C(1), “stage Ia” as element C(2), and so forth, with “stage IV” being represented by array element C(6).

At step 227, each record in the ‘search set’ 501 of clinical trial records (stored in local database 107) is also normalized, in accordance with the criteria established in step 220, to generate a normalized search set 515 of clinical trial records 520. The normalized data in each record 520 (n) of search set array 515 is stored in the same format as criteria array 511 described in Step 225. Any records 520(n) not having any of the search criteria that appear in the initial criteria array 509 are eliminated from search set 515. Each record 520 in search set 515 also contains information in a header, or other field, indicating the name or ID of the associated clinical trial.

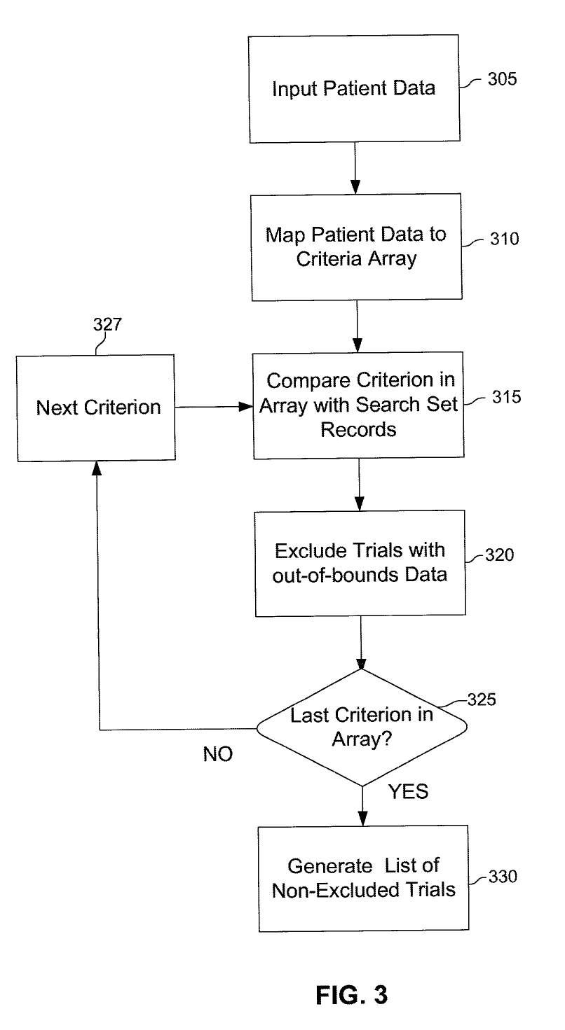

At step 230, a patient medical information form containing a short list of approximately 20 to 30 questions (hereinafter called ‘question list’ 513) is generated from initial criteria array 509. This set of questions, which are based on the exclusionary criteria in the clinical trials, allows search engine 100 to efficiently eliminate the trials that are irrelevant to a given patient, by a process described in detail below with respect to FIG. 3.

In step 230, the initial criteria array 509 of potential criteria, as generated in step 225, is now reduced to generate a reduced criteria array 511 having between approximately 20 and 30 entries, each of which consists of a single criteria (or sub-criteria). It is of practicable significance in carrying out the present method that there are no more than approximately 25 to 30 entries in the resultant criteria array 511, as each of these entries is used as the basis of one of the questions in question list 513. The present method will, of course, operate with more than 30 questions, but as this number increases, the usefulness of the method as a time saving tool for the patient's physician is reduced accordingly. The requirement of a relatively small question list is effectively necessitated by the physician's extremely limited time available to process clinical trial information (or any other type of information) for a given patient.

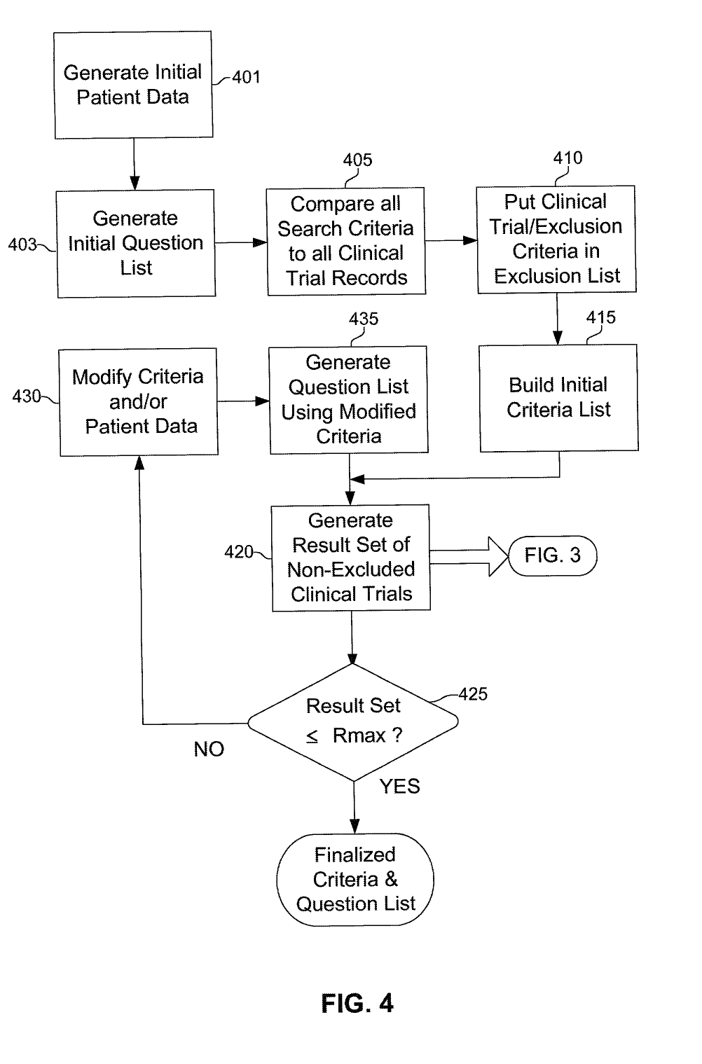

The process by which the number of entries in initial criteria array 509 is reduced to build reduced criteria array 511 in the present step is explained in detail below with respect to FIG. 4. After reduced criteria array 511 is generated, question list 513 is then formulated to include a set of questions that correspond to the criteria represented in the array 511. An example of a question list is provided in Table 1, below. Finally, each record 520(n) in search set 515 is pared down to include only the search criteria that appear in the reduced criteria array 511.

At step 235, the patient or the patient's physician (the search engine ‘user’) then answers the set of questions in the question list 513 using information available from the patient's medical history 103. The answers to these questions are entered into computer 105, where they are received as input data by search engine 100. Reduced criteria array 511 is used as a template for receiving answers to the questions in question list 513.

Finally, at step 240, search engine 100 generates a list 110 of the clinical trials (and optionally, corresponding abstracts) found in the database 101 that match the user's input data. The process by which this list is generated is described in FIG. 3.

FIG. 3 is a flowchart illustrating exemplary steps employed by the present method to generate a relatively small list of clinical trials that meet the exclusionary criteria guidelines of each selected clinical trial in accordance with the medical history of a particular patient. Note that FIG. 3 corresponds to steps 235 and 240 in FIG. 2.

A reiterative comparison of search criteria in criteria array 511 to the clinical trial search set records 520(1)-520(n) provides a vertical reduction, with each successive iteration, of the number of comparison objects, which in this case, are (normalized) clinical trial records. This technique speeds the data search process. In other words, with so much structured data to compare, instead of checking each of the criteria in each of the clinical trials against each question the completed question list, the set of normalized clinical trial records is compared in seriatim fashion with each exclusionary criterion (question) in the question list 513, and the records are pared down with each subsequent comparison.

As shown in FIG. 3, at step 305, a patient's physician enters data (answers) from a patient's medical record 103 (or other source) into computer 105 in response to questions in the question list 513 displayed by the computer. At step 310, the data entered for each question in question list 513 is mapped to criteria array 511, i.e., the data corresponding to each search criterion (for which a question was answered) is entered into a corresponding element of the criteria array.

At step 315, each search criterion in criteria array 511 having a non-zero value is compared, one at a time, with the corresponding search criterion, if any, in each of the clinical trial search set records 520(1)-520(n) in criteria array 511. This process is analogous to asking a question such as, “Does this clinical trial accept patients with stage 2 cancer?” If the particular clinical trial does not accept this type of patient, and the search criteria indicates that the patient has a stage 2 cancer, the trial is immediately excluded, and then only remaining clinical trial records are subsequently checked against the present criteria and other remaining criteria. If the patient's doctor did not enter the information for a particular search criterion into the completed question list, that criterion is entered in the criteria array 511 as a “0”, which has the same significance as a criterion that is not applicable.

Conversely, if the current criterion (corresponding to a response entered into the question list 513) in the criteria array 511 does not appear in the clinical trial search set record 520(n) for this clinical trial, then the current criterion is ignored, and the current criterion is compared against the next clinical trial record in the search set 515. If a match is found between a current search criterion and a corresponding criterion in the current search set record 520(n), then the current criterion does not allow inclusion based on this matching of exclusionary criteria. Therefore, this particular clinical trial is excluded on that data alone, and no further checking of this clinical trial record 520(n) is performed. This elimination of non-qualifying clinical trials is indicated at step 320.

As indicated above, in order to allow the search process to be as straight-forward as possible, each of the search criteria in both the criteria array and the clinical trial search set is considered to be of a different “type”, including “sub-criteria” (even though the sub-criteria are categorically related). This allows a straightforward comparison to be made between search criteria and clinical trial criteria, without having to make a separate, different comparison for sub-criteria having a range of possible values.

After the criterion for the first question in the question list is compared against all the records still in the clinical trial search set 515, a further narrowing down is made of the number of clinical trials for which a given patient is qualified. The entire process described immediately above is repeated (by performing steps 315-327) with the each subsequent criterion in the criteria array, until all clinical trials have been eliminated (at step 325) or all of the criteria have been compared against all of the records in the clinical trial search set. Each pass (iteration) through the database results in fewer trials to which the patient's qualifications are compared. The resulting search is faster and at any iteration generally has fewer clinical trial records in the result set than the set from the previous iteration.

FIG. 4 is a flowchart illustrating exemplary steps which may be performed by a pre-processor in the present system to generate a list containing a minimal number of criteria which can then be posed as questions to a user of the search engine. The pre-processor can be advantageously integrated into search engine 100, to utilize the database query functionality thereof. Alternatively, a separate computer program can be utilized to select an optimized set of criteria. The process illustrated by the flowchart of FIG. 4 determines a set of criteria used to formulate a corresponding set of questions that reduce the number of applicable clinical trials for a given patient's medical history.

A seemingly obvious assumption is illustrative of the non-obviousness of the present invention. It would appear that the largest number of applicable clinical trials would exist in the case of a very ill patient who was willing to travel to a clinical trial anywhere in the United States. Such a patient would appear to be eligible for a large number of trials, because, in addition to the all-encompassing geographic scope of potentially available trials, one would assume that a large number of the trials would accept patients having symptoms well-defined by the advanced stage of a particular disease. However, this intuitive assumption is incorrect. In fact, the very ill patient has poor lab values, such as low neutrophils because her immune system is weak, low hemoglobin because of anemia, and so on. Most clinical trials provide fairly precise ranges of “acceptable” for these lab values, therefore, even the very ill patient willing to go anywhere would not qualify for an excessively large number of trials.

Instead, it was observed that a problem existed in the case of a relatively healthy woman willing to go anywhere, and who had close to normal lab values. Namely, this category of patient qualified for such a large number of trials using initial search criteria that the number of results had to be significantly pared down in order to be manageable by the typical physician. In view of the above observation, it was thus concluded that the criteria generated by the present system at step 225 had to be more restrictive. Therefore, an iterative process of elimination of criteria is performed until a satisfactory maximum number of search results is obtained for the near-worst case test set of data for a typical woman having close to normal lab values.

As shown in FIG. 4, at step 401, initial patient data is generated for a hypothetical near-worst case patient, such as a typical patient having close to normal lab values. At step 403, an initial set of search criteria is generated using all of the criteria in initial criteria array 509. This data is then entered into the question list 513 as the initial set of questions.

At step 405, each of the search criteria in criteria array 511 is compared against each of the clinical trial records 520(n) to generate, at step 0, an ‘exclusion list’ 525, containing the following data:

(a) indicia (ID) of the clinical trial that was excluded; and

(b) the search criterion (corresponding to a question in question list 513) that excluded the trial.

The excluded clinical trials (‘exclusion list’) 525 are determined by processing the current set of questions via a loop consisting of steps 310-327 shown in FIG. 3. Note that, in subsequent passes through the loop consisting of steps 420-435 in FIG. 4, only the clinical trials remaining after (i.e., that are not excluded by) the search criteria/clinical trial record comparison are used as a further basis of comparison.

Since all of the data has been formatted in consistent ‘normalized’ categories, at this point it is a straightforward process to determine exactly which criteria exclude which specific cases. At step 415, search engine 100, or other program running on computer 105, generates an initial list of criteria (‘criteria count list’) 535, ordered by frequency of occurrence, that function to exclude the clinical trials in the exclusion list 525. Each entry in criteria count list 535 includes indicia identifying the criterion, and a count field indicating how many clinical trials were excluded by the instant criteria. A portion of an exemplary criteria count list 535 is shown below:

| Criterion | Count |
|---|---|
| Bilirubin 1.30-1.49; | 45 |
| Bilirubin 1.50-1.99; | 39 |
| Creatinine 1.50-1.99; | 38 |
| Current Chemotherapy; | 35 |
| Prior hormonal breast cancer Rx; | 32 |

Alternatively, entries in the criteria count list 535 may be heuristically selected based on knowledge of an expert in the relevant field. It was discovered that a set of ‘prior therapies’, e.g., prior radiation, prior chemotherapy, prior hormonal therapy, etc., resulted in a small and manageable set (i.e., 25 or fewer), even for the relatively healthy woman with good lab values. Specifically, all the exclusionary criteria were examined once again to see what other criteria could be employed. It was observed that a relatively large percentage of trials had “prior treatment” exclusions, such that a patient who had had certain types of prior chemotherapy, prior radiotherapy and/or prior biologic therapy were often excluded. It was also discovered, more specifically with respect to prior therapies, that there were several blood chemistry criteria that, when included in the question list, provided a significant improvement (increase) in the number of clinical trials excluded. More specifically, in the case of breast cancer clinical trials, these criteria include data relating to platelets, hemoglobin, creatinine, bilirubin, and absolute neutrophil count, as can be seen from question list 513 in Table 1. Therefore, in an exemplary embodiment, certain prior therapies are selected to be included in the initial set of questions used in the question list.

The criteria array 511 (and corresponding question list 513) that is used in the first pass through the loop of steps 420-435 (described below) is then formulated using a predetermined number, for example 15 (not counting the group of U.S. states), of the search criteria having the greatest frequency of occurrence in criteria count list 535.

Next, at step 420, a list of non-excluded clinical trials (i.e., those trials for which the present hypothetical patient qualifies) is generated by processing the current set of questions in question list 513 via a loop consisting of steps 315-327 shown in FIG. 3. Thus, search engine 100 not only generate lists of clinical trials matching patient input data, the search engine also functions to optimize the performance of the present system.

At step 425, if the resulting set of clinical trials is greater than a predetermined number Rmax, the search criteria in criteria array 511 (and corresponding question list 513) are modified in accordance with the procedure described below with respect to step 430. In an exemplary embodiment, Rmax is selected to be between approximately 5 and 10 clinical trials. The exclusionary criteria are then reexamined (if necessary) to determine how many clinical trials are excluded/included by a modified set of questions.

Next, the search criteria in the criteria array 511, and the corresponding questions in question list 513 are modified to determine the best question set (i.e., the set of questions in question list 513). The objective of the process shown on FIG. 4 is to select between approximately 20 and 30 of the criteria that exclude the most clinical trials not applicable for a given patient, based on the data generated in step 420. Accordingly, at step 430, the set of questions in question list 513 is modified by adding additional criteria/questions to criteria array 511/question list 513 to determine the minimum number of criteria/questions that exclude a sufficient number of the trials. Ideally, a set of approximately 25 criteria/questions (not counting the group of U.S. states) is determined that yields a result set of approximately 5 clinical trials.

Alternatively, at any iteration of step 430, the patient data generated in step 401 can be modified in lieu of modifying the search criteria/question list. This alternative may be necessary in the situation where the originally chosen, hypothetical patient data results in to few or too many clinical trial remaining at this point.

At step 435, the search criteria in criteria array 511 and corresponding question list 513 is modified by adding, to the search criteria, the criterion in the criteria count list 535 having the next greatest frequency of occurrence (as compared to the criteria already selected from the list). The loop consisting of steps 420-435 is then repeated until a satisfactory minimum number of clinical trials are returned in the result set by search engine 100, at step 425.

Table 1, below, a summary page showing the questions in a typical question list 513 used by the present search engine to select clinical trials. Note that the questions in Table 1 are specifically applicable to breast cancer clinical trials.

TABLE 1
PATIENT QUESTION LIST—Breast Cancer

Non-Health-related Information:

| | |
|---|---|
| 1. | Age |
| 2. | Location (This entry is actually a group of 56 sub-entries including the U.S. |
| | states and territories) |

Status of Disease:

| | |
|---|---|
| 3. | Recurrent ( ) - check if yes |
| 4. | Stage I ( ), IIa ( ), IIb ( ), IIIa ( ), IIIb ( ), IV ( ) - choose the appropriate box |
| 5. | Performance status (convert ECOG to Karnovsky) |
| | <60 ( ), 60-79 ( ), 80-89 ( ), 90-100 ( ) - choose correct value |
| 6. | CNS metastases ( ) - check if yes |

Chemotherapy:

| | |
|---|---|
| 7. | Current Chemotherapy - check if yes ( ) |
| 8. | Less than 4 weeks since prior chemo ( ) |

Hormonal/Endocrine Therapy:

| | |
|---|---|
| 9. | Current Chemotherapy ( ) |
| 10. | Concurrent HRT (Hormone Replacement Therapy) ( ) |
| 11. | Concurrent use of Tamoxifen/Raloxifene ( ) |
| 12. | Prior hormonal Rx for breast cancer ( ) |
| 13. | Less than 4 weeks since hormonal Rx ( ) |

Radiotherapy:

| | |
|---|---|
| 14. | Less than 4 weeks since prior chemotherapy ( ) |
| 15. | Prior radiation to the breast or regional lymph nodes ( ) |
| 16. | Prior radiation for any cancer ( ) |

Biologic Therapy:

| | |
|---|---|
| 17. | Prior biologic therapy for breast cancer ( ) |
| 18. | Prior herceptin ( ) |
| 19. | Concurrent CSFs (colony stimulating factors) ( ) |
| 20. | Prior other malignancy within the last 5 years (excluding in situ cervical |
| | cancer and adequately treated basal and squamous cell cancer) ( ) |

Blood Chemistry:

| | | |
|---|---|---|
| 21. | Platelets | <50( ), 51-99( ), >99( ) |
| 22. | Hemoglobin | <=8 g/dL ( ), 8.1-9.0 g/dL ( ), 9.1-10.0 g/dL ( ), l0.0 g/dL ( ) |
| 23. | Creatinine | <1.50 ( ), 1.50-1.99 ( ), 2.00-2.25 ( ), >2.25 ( ) |
| 24. | Bilirubin | <1.30 ( ), 1.30-1.49 ( ), 1.50-1.99 ( ), >2.00 ( ) |
| 25. | Absolute Neutrophil count | <1,500 ( ) >1,500( ) |

TABLE CT1
Paclitaxel and Capecitabine in Treating Patients With Metastatic Breast Cancer
Conditions: stage IV breast cancer; recurrent breast cancer

| Eligibility | |
|---|---|
| 1. | Ages Eligible for Study: 18 Years-75 Years Criteria |

PROTOCOL ENTRY CRITERIA:

Disease Characteristics

| | |
|---|---|
| 2. | Histologically or cytologically confirmed metastatic breast cancer |
| 3. | Bidimensionally measurable disease |
| 4. | Hormone receptor status: Not specified |

Prior/Concurrent Therapy

| | |
|---|---|
| 5. | Biologic therapy: Not specified |
| 6. | Chemotherapy: |
| | Eligible patients may have received prior chemotherapy in metastatic or |
| | adjuvant setting with the following exceptions: |
| 7. | At least 12 months since prior fluoropyrimidine therapy At least 12 months |
| | since prior taxane therapy |
| 8. | Only 1 previous chemotherapeutic regimen in the metastatic setting |
| 9. | Endocrine therapy: Not specified |
| 10. | Radiotherapy: At least 4 weeks since prior radiotherapy |
| 11. | Surgery: Not specified |

Patient Characteristics
Age: 18 to 75

| | |
|---|---|
| 12. | Sex: Female |
| 13. | Menopausal status: Not specified |
| 14. | Performance status: Karnofsky 70-100% |
| 15. | Life expectancy: Not specified |
| 16. | Hematopoietic: ANC at least 1,500/mm3 |
| 17. | Platelet count at least 100,000/mm3 |
| 18. | Hepatic: Bilirubin less than 1.5 times upper limit of normal (ULN) |
| 19. | Renal: Creatinine less than 1.5 tunes ULN |
| 20. | Other: Not pregnant or nursing |
| 21. | Negative pregnancy test |
| 22. | Fertile patients must use effective contraception |

[End Table CT1]

TABLE CT2
Paclitaxel Plus Radiation Therapy in Treating
Women With Stage II or Stage III Breast Cancer
Conditions: stage IIIB breast cancer; stage IIIA breast cancer; stage II breast cancer

Eligibility

| | |
|---|---|
| 1. | Ages Eligible for Study: 18 Years and above Criteria |

PROTOCOL ENTRY CRITERIA:

Disease Characteristics

| | |
|---|---|
| 2. | Stage II or III invasive breast cancer |
| 3. | Prior breast conserving surgery (lumpectomy or quadrantectomy) with |
| | ipsilateral axillary lymph node dissection required |
| 4. | No prior contralateral breast cancer |
| 5. | No metastatic disease |
| 6. | Prior ductal carcinoma in situ or lobular carcinoma in situ of the breast |
| | allowed unless treated with radiation or chemotherapy |
| 7. | Doxorubicin and cyclophosphamide adjuvant chemotherapy completed within |
| | past 3 weeks |
| 8. | Candidate for definitive radiotherapy |
| 9. | Hormone receptor status: Not specified |

Prior/Concurrent Therapy

| | |
|---|---|
| 10. | Biologic therapy: No concurrent filgrastim (G-CSF) |

Chemotherapy: See Disease Characteristics

| | |
|---|---|
| 11. | Prior tamoxifen allowed |
| 12. | No concurrent tamoxifen |
| 13. | Endocrine therapy: Not specified |
| 14. | Radiotherapy: No prior radiation to the breast |
| 15. | Surgery: Recovered form prior surgery |
| 16. | Other: No concurrent adjuvant therapy on another clinical trial |

Patient Characteristics
Age: 18 and over

| | |
|---|---|
| 17. | Sex: Female |
| 18. | Menopausal status: Not specified |
| 19. | Performance status: ECOG 0-1 |
| 20. | Life expectancy: Not specified |

Hematopoietic:

| | |
|---|---|
| 21. | WBC at least 3,000/mm3 |
| 22. | Granulocyte count at least 2,000/mm3 |
| 23. | Platelet count at least 100,000/mm3 |
| 24. | Hepatic: Bilirubin no greater than 1.5 times upper limit of normal (ULN) |
| 25. | ALT/AST no greater than 1.5 times ULN |
| 26. | Renal: Creatinine no greater than 1.5 mg/dL |

Cardiovascular:

| | |
|---|---|
| 27. | No concurrent poorly controlled ischemic heart disease or |
| 28. | Congestive heart failure |
| 29. | LVEF at least 45% by MUGA scan or echocardiogram |
| 30. | Pulmonary: No concurrent severe chronic obstructive or restrictive pulmonary |
| | disease |

Other:

| | |
|---|---|
| 31. | Not pregnant or nursing |
| 32. | Fertile patients must use effective contraception |
| 33. | No concurrent severe medical or psychiatric illness |
| 34. | No concurrent severe diabetes mellitus |
| 35. | No other prior malignancy within the past 5 years except nonmelanoma skin |
| | cancer or carcinoma in situ of the cervix treated with local excision |

[End Table CT2]

TABLE CT3
Phase I/II Study of Annamycin Liposomal in Patients With Anthracycline-Resistant
Locally Advanced or Metastatic Breast Cancer
Conditions: stage IIIB breast cancer; male breast cancer; stage IIIA breast cancer;
stage IV breast cancer; recurrent breast cancer

Eligibility
Ages Eligible for Study: 18 Years and above Criteria

PROTOCOL ENTRY CRITERIA:

Disease Characteristics
Diagnosis of locally advanced or metastatic breast cancer

| | |
|---|---|
| 1. | High likelihood of anthracycline resistance due to prior anthracycline |
| | exposure in the adjuvant or metastatic setting |
| 2. | Prior anthraquinone (e.g., mitoxantrone) insufficient |
| 3. | Prior cumulative anthracycline dose limited to doxorubicin-equivalent 350 |
| | mg/m2 by IV bolus or 450 mg/m2 by prolonged (at least 48 hours) infusion |
| 4. | Measurable or evaluable disease |
| 5. | Brain metastases treated by prior surgery and/or radiotherapy allowed if |
| | neurologic status stable 2 weeks after discontinuation of dexamethasone |
| 6. | Hormone receptor status: Not specified |

Prior/Concurrent Therapy

| | |
|---|---|
| 7. | Biologic therapy: No concurrent prophylactic filgrastim (G-CSF) |
| 8. | Chemotherapy: See Disease Characteristics At least 3 weeks since prior |
| | chemotherapy |
| 9. | (6 weeks for mitomycin or nitrosourea) and recovered |
| 10. | Endocrine therapy: See Disease Characteristics |
| 11. | Radiotherapy: See Disease Characteristics At least 3 weeks since prior |
| | radiotherapy and recovered |
| 12. | Surgery: See Disease Characteristics |

Patient Characteristics

| | |
|---|---|
| 13. | Age: 18 and over |
| 14. | Sex: Male or female |
| 15. | Menopausal status: Not specified |
| 16. | Performance status: Zubrod 0-2 |
| 17. | Life expectancy: At least 12 weeks |

Hematopoietic:

| | |
|---|---|
| 18. | Absolutegranulocyte count greater than 1,500/mm3 |
| 19. | Platelet count greater than 100,000/mm3 |
| 20. | Hepatic: Bilirubin no greater than 1.5 mg/dL |
| 21. | Renal: Creatinine no greater than 1.5 mg/dL |

Cardiovascular:

| | |
|---|---|
| 22. | No history of heart failure |
| 23. | Ejection fraction at least 55% by 2-dimensional echocardiogram |

Other:

| | |
|---|---|
| 24. | Not pregnant or nursing |
| 25. | Negative pregnancy test |
| 26. | Fertile patients must use effective contraception |
| 27. | Other prior malignancy allowed if curatively treated and there is clear |
| | diagnosis of metastatic breast cancer requiring treatment |

[End Table CT3]

While exemplary embodiments of the present invention have been shown in the drawings and described above, it will be apparent to one skilled in the art that other practicable embodiments of the present invention are possible. For example, the specific configuration of the various records, lists and arrays as well as the particular flowchart steps and sequences thereof described above should not be construed as limited to the specific embodiments disclosed herein. Modification may be made to these and other specific elements of the invention without departing from its spirit and scope as expressed in the following claims.

What is claimed is:

1. A method for determining a search set of clinical trials, the method comprising the steps of:
determining a subject area of interest;
searching a clinical trial database for specific instances of the clinical trials in the subject area of interest;
generating a list of said clinical trials by extracting, from the database, a plurality of records in the subject area of interest;
extracting exclusionary criteria in each record from the initial list;
generating a list of redundant instances of the exclusionary criteria;
generating a set of normalized criteria by normalizing the criteria in the list of redundant instances;
generating a reduced set of said normalized criteria by reducing the number of members in the normalized list by selecting a predetermined maximum number of exclusionary criteria in the normalized list having the most redundancy; and
generating a normalized search set of the clinical trials in the reduced list, using the reduced set of normalized criteria.

2. The method of claim 1, wherein a patient is matched with a set of appropriate clinical trials, including the steps of:
generating a list of questions using the normalized search set;
receiving input data from the patient in response to said list of questions; and
generating a target list of the clinical trials by comparing the input data from the patient with the list of questions and the list of clinical trials.

3. The method of claim 2, further including the steps of:
determining geographical preferences for the patient; and
generating a reduced target list of said clinical trials by extracting, from the target list, all records having indicia that match said geographical preferences.
